(19) United States
(12) Patent Application Publication
(10) Pub. No.: US 2026/0319985 A1
(43) Pub. Date: Oct. 15, 2026

(54) SYSTEMS AND METHODS FOR ROUTING SIGNALS FROM A MEDIA PLAYER

(71) Applicant: RIGH, INC., Palo Alto, CA (US)

(72) Inventors: Hieu Dinh Liem VO, Saratoga, CA (US); Jeffrey ChiFai LIEW, Millbrae, CA (US); Richard CHANG, Los Altos Hills, CA (US); Timothy NGUYEN, San Jose, CA (US); Miroslav SAMARDZIJA, Mountain View, CA (US); Meng-Jung CHUANG, Taipei (TW)

(21) Appl. No.: 19/173,902

(22) Filed: Apr. 9, 2025

(51) Int. Cl. G06F 13/38

(52) U.S. Cl. CPC G06F 13/387; G06F 2213/0054; G06F 2213/3852

(57) ABSTRACT

The present disclosure relates to a system for managing media signal transmission, processing, and power distribution. In some embodiments, the system includes a multifunction hub configured to deliver both power and signal transmission to a media player. The multifunction hub comprises signal processing circuitry, including an HDMI splitter or USB Type-C output driver, to facilitate media distribution. The media player is configured to receive, process, and output media signals while also supporting buffering, image analysis, and screen capture functions. In some embodiments, a secondary signal is routed back to the media player for additional processing, ensuring uninterrupted playback. The system further includes configurations that include a splitter puck, which enables signal duplication while maintaining independent power delivery via a separate power interface. Various embodiments provide modular configurations that optimize signal routing, buffering, and adaptive processing for improved media transmission efficiency and stability across multiple devices.

### FIELD OF THE DISCLOSURE

The present disclosure relates to systems and methods for managing media signal transmission, processing, and power distribution. More particularly, the disclosure pertains to a hub, a media player, and associated components configured for signal duplication, buffering, and power regulation.

### SUMMARY OF THE DISCLOSURE

This disclosure is directed to novel configurations of a system for receiving, splitting, and returning signals received from an electronic computing device, such as a media player. In some embodiments, the system includes circuitry configured for signal processing, buffering, and/or power management. In some embodiments, the media player includes an integrated processing system configured to decode and render media signals, perform image analysis, and facilitate screen capture operations. Signal duplication circuitry enables simultaneous transmission of a primary media signal to an external display while routing a secondary signal back to the media player for additional processing. In some embodiments, buffering functionality is incorporated to ensure uninterrupted playback, mitigating potential frame drops or transmission inconsistencies.

In some embodiments, the system includes a multifunction hub that includes signal transmission output circuitry, which may include an HDMI splitter or USB Type-C output driver, configured to facilitate video and/or audio signal distribution. In some embodiments, the multifunction hub is configured to manage both power delivery and signal distribution. The multifunction hub includes an external housing that encases power input prongs, signal transmission ports, and internal circuitry configured for media signal processing. The media player is configured to receive power from the multifunction hub while processing and transmitting video and audio signals. A multifunction cable extends from the hub and terminates in a multifunction plug, which enables both power and signal transfer to the media player.

In some embodiments, the media player is configured to engage with a splitter puck for signal duplication and routing. In some embodiments, the splitter puck includes a housing with a conforming profile, shaped to align with the media player. In some embodiments, the media player housing is configured to conform to the shape of the splitter puck. Like the multifunction hub, the splitter puck includes internal signal processing circuitry configured to split an incoming signal into separate outputs. A first signal output is transmitted to an external source, while a second signal output is routed back to the media player for additional processing. In some embodiments, the power interface is configured to be separately coupled to the media player, providing direct power delivery without being physically connected to the splitter puck. In some embodiments, the power interface is configured to couple to the splitter puck, where the splitter puck is configured to deliver the power into the media player through the same circuit as the return signal. The various configurations of the system described herein, in accordance with some embodiments, enable a more compact signal and power transmission pathway while maintaining an integrated media processing system.

### BRIEF DESCRIPTION OF THE DRAWINGS

The features and advantages of the disclosure will be apparent from the following description of some embodiments as illustrated in the accompanying drawings, in which reference characters refer to the same parts throughout the various views. The drawings are not necessarily to scale, emphasis instead being placed upon illustrating principles of the disclosure:

FIG. 1A illustrates a multifunction hub configured to provide power and signal transmission to a media player, in accordance with some embodiments of the disclosure.

FIG. 1B depicts the first signal output on a bottom portion of the hub housing, in accordance with some embodiments of the disclosure.

FIG. 1C depicts the first signal output on a side portion of the hub housing, in accordance with some embodiments of the disclosure.

FIG. 1D depicts the first signal output on a front face of the hub housing, in accordance with some embodiments of the disclosure.

FIG. 1E shows an alternate configuration of the multifunction cable that is configured to plug into the hub housing, as well as first signal output in another location, in accordance with some embodiments of the disclosure.

FIG. 2 shows the multifunction hub coupled to the media player, in accordance with some embodiments of the disclosure.

FIG. 3 illustrates the multifunction hub in a decoupled and coupled state relative to the media player, in accordance with some embodiments of the disclosure.

FIG. 4 depicts a configuration in which a splitter puck is engaged with the media player for signal duplication, in accordance with some embodiments of the disclosure.

FIG. 5 illustrates a configuration in which the media player includes a conforming profile to receive the splitter puck, in accordance with some embodiments of the disclosure.

FIG. 6 shows the system in a decoupled and coupled state, in accordance with some embodiments of the disclosure.

FIG. 7 depicts a signal processing flow, in accordance with some embodiments of the disclosure.

### DETAILED DESCRIPTION

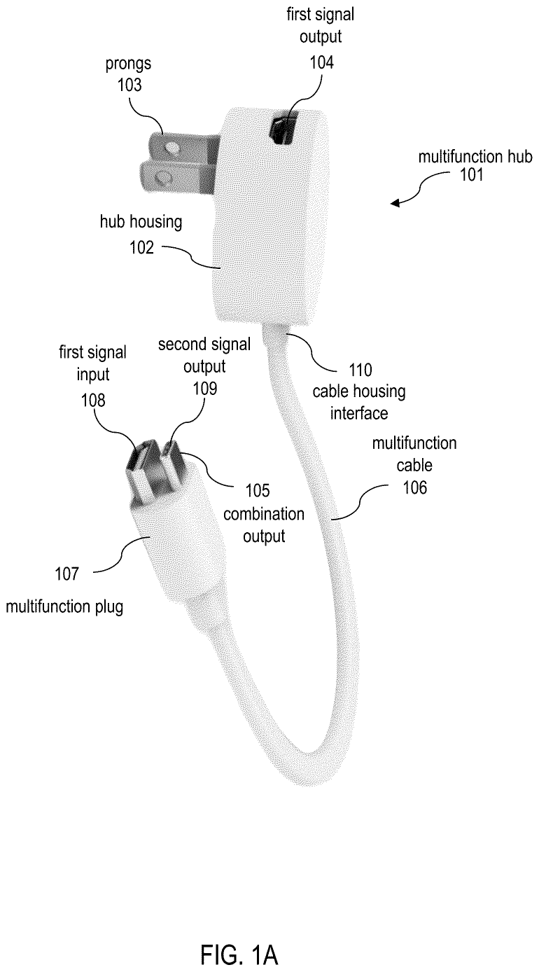

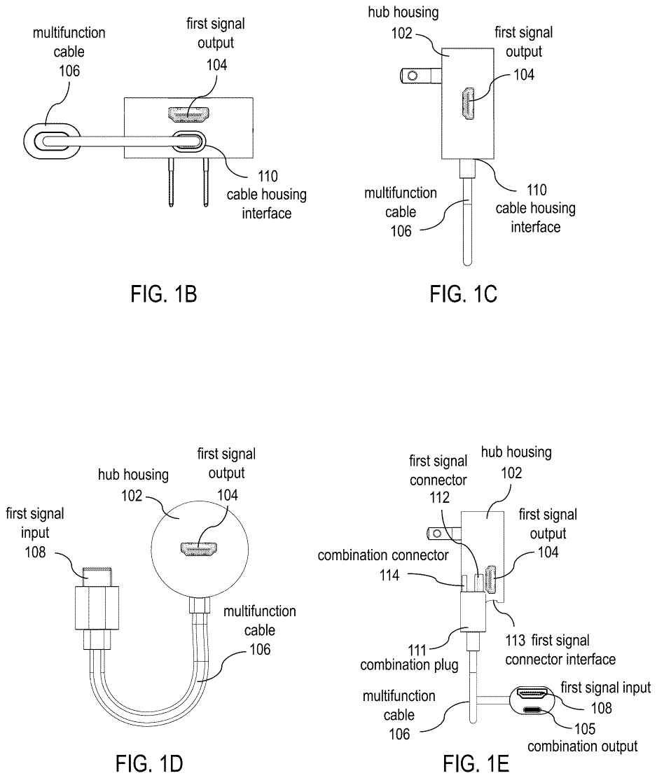

Referring to FIG. 1A, in some embodiments, the system includes a multifunction hub 101 configured to function as both a power delivery module and a signal splitter. The multifunction hub 101, in this non-limiting example, includes a hub housing 102 that encases internal circuitry and components. Shown extending from the hub housing 102 are power input prongs 103, which are configured to couple to an alternating current (AC) power source to provide electrical power to the system.

In some embodiments, the multifunction hub 101 further includes a first signal output 104, which is configured to transmit an output signal to an external display or processing unit. The first signal output 104 may be an HDMI port, DisplayPort, USB-C, or another suitable signal interface. In some embodiments, the multifunction hub 101 comprises a combination output 105, which is configured to transmit both power and data through a multifunction cable 106.

In some embodiments, the multifunction cable 106 extends from the hub housing 102 and is configured to deliver both power and signal (e.g., media signals) transmission. In some embodiments, the multifunction cable 106 terminates in a multifunction plug 107, which includes a first signal input 108 configured to receive a media signal from an external device, such as a media player. In some embodiments, the multifunction plug 107 includes a second signal output 109, which is configured to transmit a processed signal back to the media player for further processing. Although shown with only two output channels for splitting, any number of channels may be formed from the multifunction hub 101 circuitry.

In some embodiments, the multifunction hub 101 and its associated components are configured to manage both power distribution and signal splitting. In some embodiments, the hub housing 102 may include internal components configured to manage power distribution, signal processing, and/or data transmission. The hub housing 102 includes power management circuitry, which may comprise a USB Type-C Power Delivery controller configured to negotiate and regulate power output to connected devices, in accordance with some embodiments. Voltage regulation circuitry includes voltage regulators and boost converters configured to ensure appropriate voltage levels for different subsystems, such as 5 volts (V) for High-Definition Multimedia Interface (HDMI) components and 3.3 V for logic circuits. Power protection circuitry includes overcurrent protection and thermal regulation components, in accordance with some embodiments, configured to prevent damage caused by power surges, overheating, or excessive current draw.

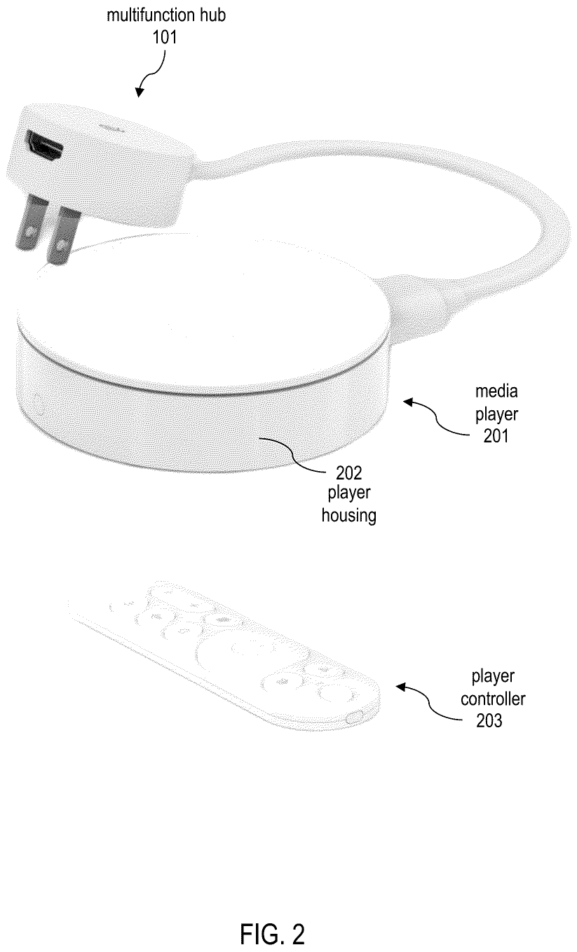

In some embodiments, multifunction hub 101 includes (e.g., HDMI) signal processing circuitry configured to receive, process, and distribute media signals. In some embodiments, a signal input receiver circuit of the multifunction hub 101 includes an integrated circuit (IC) configured to decode an HDMI signal received from a media player. In some embodiments, the signal is processed through an HDMI signal duplication circuit, which includes an HDMI splitter or repeater IC configured to duplicate the HDMI signal for transmission to both a connected display and the media player (e.g., media player 201 of FIG. 2, discussed herein). In some embodiments, an HDMI output driver circuit ensures signal integrity by applying equalization and buffering to maintain video quality over extended cable lengths. While various examples herein are described as including HDMI or USB Type-C circuitry, the system can be adapted to any type of signal transmission framework.

For signal conversion, in some embodiments, HDMI-to-USB Type-C conversion circuitry enables video transmission through USB Type-C DisplayPort Alternate Mode (Alt Mode). In some embodiments, the HDMI-to-DisplayPort conversion circuit includes an IC configured to convert HDMI audio and video data to a DisplayPort signal format. In some embodiments, a USB Type-C Alt Mode controller circuit is configured to manage the transmission of video data over the USB Type-C connection. Although an HDMI interface is used in this non-limiting example, two USB-C connectors may be used, and/or any type of signal transmission interface, so long as at least one signal transmission interface is configured to deliver both electrical power and a video signal simultaneously.

Signal transmission output circuitry (e.g., USB Type-C) facilitates data and power transmission through the multifunction plug 107. In some embodiments, the USB Type-C data and power switching circuit includes components configured to manage the distribution of video signals and power through the USB Type-C output. In some embodiments, an electronic marker (eMarker) identification circuit within hub housing 102 includes an eMarker chip configured to communicate with connected USB Type-C devices to determine appropriate power and data transfer settings. A USB Type-C output driver circuit is configured to transmit DisplayPort signals and power to a connected device, such as media player 201, discussed further, infra.

In some embodiments, auxiliary system control circuitry includes components configured to enable signal management and device communication. In some embodiments, the multifunction hub 101 includes an Extended Display Identification Data (EDID) storage circuit, which may include an Electrically Erasable Programmable Read-Only Memory (EEPROM) configured to store EDID data, ensuring proper communication between the media player and the connected display. In some embodiments, the microcontroller-based system management circuit consists of a microcontroller configured to manage logic control, power switching, and communication between the HDMI and USB Type-C subsystems. Status indicator circuitry incorporates light-emitting diodes (LEDs) configured to provide visual feedback on power delivery, signal transmission, and connection status, provided on the hub housing 102 in accordance with some embodiments.

The first signal output 104 may be placed in a variety of locations on the signal hub housing 102. For example, FIG. 1B depicts the first signal output 104 on a bottom portion of the hub housing 102, wherein the first signal output 104 is substantially aligned with the cable housing interface 110, in accordance with some embodiments. FIG. 1C shows another configuration that depicts the first signal output 104 on a side portion of the hub housing 102, rotated 90° from the cable housing interface 110, in accordance with some embodiments. FIG. 1D depicts yet another configuration where the first signal output 104 is located on a front face of the hub housing 102 on an opposite side as the prongs 103, in accordance with some embodiments of the disclosure.

In some embodiments, the multifunction cable 106 includes a combination plug 111 that is detachable from the hub housing 102 as illustrated in FIG. 1E. In some embodiments, the combination plug 111 includes a first signal connector 112 configured to couple to a first signal connector interface 113 on the hub housing 102, and also includes a combination connector 114 configured to couple to a combination connector interface on the hub housing 102. While not shown in FIG. 1E, the combination connector interface is located below and/or is aligned with the first signal connector interface 113 in a similar location as the cable housing interface 110 shown in FIG. 1B. In some embodiments, the combination connector interface is configured to deliver combined signal and electrical power from hub housing 102 to the combination output 105, as previously described. In addition, FIG. 1E also shows yet another location for the first signal output 104, which, in this non-limiting example, is less than 90° from the first signal connector interface 113 (and/or combination connector interface). Thus, the first signal output 104 may be located anywhere on any hub housing described in one or more figures.

Turning to FIG. 2, the multifunction hub 101 is configured to manage power delivery and signal distribution between the media player 201 and other connected components, which may include displays, processors, etc., in accordance with some embodiments. As discussed supra, in some embodiments, the multifunction hub 101 is configured to be coupled to the media player 201, which serves as a signal source and is configured to generate and transmit a media signal for processing and distribution. The multifunction hub 101 receives power through the power input prongs 103, which are configured to couple to an external power source (not shown).

In some embodiments, the media player 201 is configured to generate, process, and transmit media signals to external devices through the multifunction hub 101. The media player 201 includes internal components configured to support media decoding, signal output, and/or bidirectional communication with connected peripherals. The media player 201, in accordance with some embodiments, is configured to receive power and data through the multifunction plug 107, which is coupled to the multifunction hub 101. The media player 201 is further configured to process incoming media content, generate video and audio signals, and output the processed signals for transmission.

In some embodiments, the media player 201 includes media processing circuitry, which, in some embodiments, may include a system-on-chip (SoC) or dedicated multimedia processor configured to decode and render various media formats, including high-definition and ultra-high-definition video signals. The media processing circuitry may be configured to handle standard media codecs such as H.264, H.265 (HEVC), and VP9, ensuring compatibility with a wide range of content. In some embodiments, the video processing unit within the media processing circuitry is configured to apply scaling, color correction, and frame interpolation to optimize visual output.

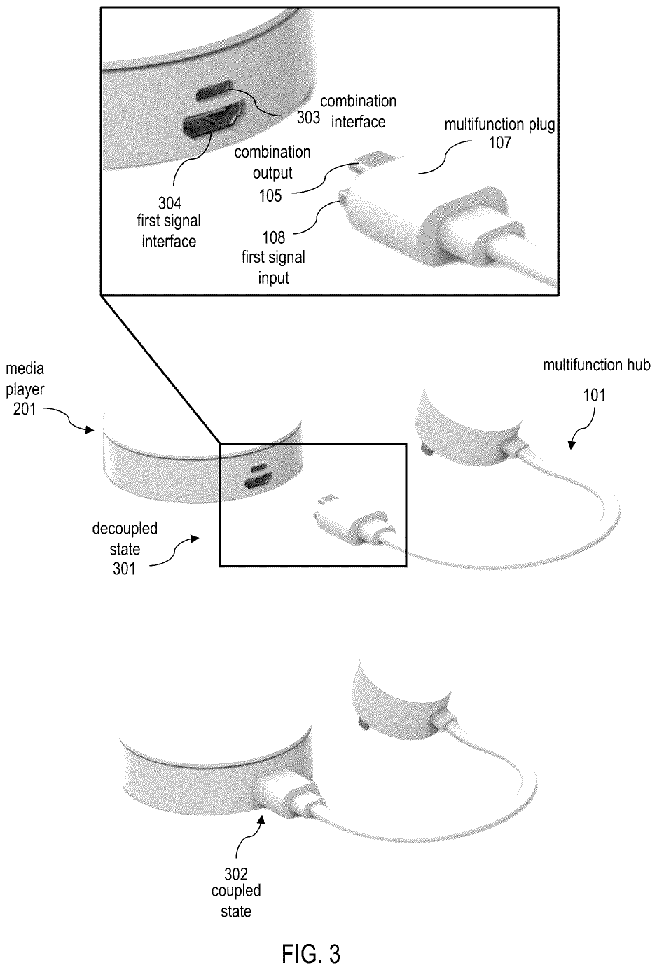

The media player 201, in some embodiments, includes signal output circuitry, described further in relation to FIG. 3, which is configured to transmit processed video and audio signals. The first signal input 108 of the multifunction hub 101 is configured to receive these signals for further processing and distribution. In some embodiments, the signal output circuitry may include an HDMI signal output driver configured to ensure signal integrity and proper formatting for transmission. In some embodiments, the media player 201 audio processing circuitry is configured to manage stereo and multi-channel audio formats, including Dolby Digital and DTS, for high-quality audio playback.

In some embodiments, the media player 201 includes power management circuitry configured to regulate incoming power received through the multifunction plug 107. The power regulation circuitry ensures appropriate voltage levels for the internal components and prevents overcurrent conditions. In some embodiments, the power management system may include energy-efficient features such as dynamic voltage scaling to optimize power consumption.

In some embodiments, the media player 201 is configured to interact with a player controller 203, which enables user input and control over media playback functions. In some embodiments, the player controller 203 is configured to send commands to the media player 201, enabling operations such as play, pause, fast-forward, rewind, and menu navigation. The media player 201 processes these commands and responds with actions such as playback, screen capture (e.g., snap), zoom, etc., in accordance with some embodiments. The player controller 203 may communicate with the media player 201 through a wired or wireless interface. In some embodiments, the player controller 203 may include infrared (IR), Bluetooth®, or radio frequency (RF) communication modules configured to transmit control signals to the media player 201. The player controller 203 may also feature additional input options such as a touchscreen, directional buttons, or voice recognition functionality to enhance user interaction.

The media player 201 may also include storage and memory components, which are configured to support media playback and buffering, in accordance with some embodiments. The system memory may include dynamic random-access memory (DRAM) configured to store temporary data for active processes, as well as non-transitory memory and one or more processors for executing the functionality described herein. In some embodiments, the media player 201 may include non-volatile storage, such as embedded MultiMediaCard (eMMC) or NAND flash memory, configured to store applications, firmware, and/or cached media content, in accordance with some embodiments.

Referring now to FIG. 3, the system is shown in a decoupled state 301 and a coupled state 302, illustrating the engagement between the multifunction hub 101 and the media player 201 in accordance with some embodiments. The multifunction hub 101 multifunction plug 107 is configured to interface with the media player 201 through a combination interface 303. In some embodiments, the combination interface 303 includes a first signal input 108 and a combination output 105, which, in some embodiments, are configured to enable both power and signal transmission, as described above.

In some embodiments, the decoupled state 301 illustrates the multifunction plug 107 positioned apart from the player housing 202, showing the individual components before engagement. In some embodiments, the coupled state 302 illustrates the multifunction plug 107 inserted into the combination interface 303, forming an electrical and data connection between the multifunction hub 101 and the media player 201.

The zoomed-in portion of FIG. 3 shows the combination interface 303, in accordance with some embodiments. In some embodiments, the first signal interface 304 is configured to receive a media signal from the multifunction plug 107. In some embodiments, the multifunction plug 107 includes a first signal input 108, which is configured to engage with the first signal interface 304 to enable signal transmission. The combination output 105 is configured to couple to the combination interface 303 to enable both power delivery and data exchange, in accordance with some embodiments.

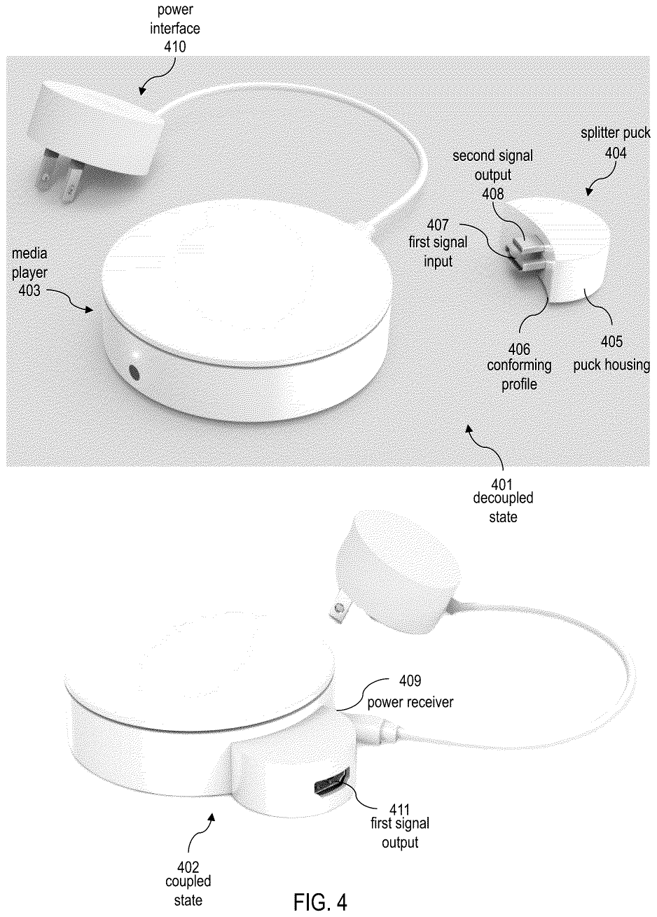

Referring now to FIG. 4, an alternative system is shown in a decoupled state 401 and a coupled state 402, illustrating the engagement between the media player 403, a splitter puck 404, and a power interface 410, in accordance with some embodiments. In some embodiments, the media player 403 is configured to receive power and signal input separately, with the power receiver 409 positioned at one location on the media player housing and the first signal input 407 located at a distinct position for sending/receiving media signals to/from the splitter puck 404. Non-limiting enabling descriptions for power and signal processing circuit arrangements are discussed in relation to other figures, and are not repeated for the various physical configurations described herein in the interest of being concise.

The decoupled state 401 illustrates the splitter puck 404 positioned apart from the media player 403, showing the individual components before engagement. In some embodiments, the splitter puck 404 includes a splitter puck 404 with a conforming profile 406, concave into the puck housing 405 in this example, which is shaped to align with the curved media player housing. The splitter puck 404 includes a second signal output 408, which, in some embodiments, is configured to transmit a media signal back into the media player as described in relation to other figures. In some embodiments, the power interface 410 is separate from the splitter puck 404 and is configured to provide power directly to the media player 403 via a power receiver 409.

The coupled state 402 illustrates the splitter puck 404 and the power interface 410 engaged with the media player. The conforming profile 406 ensures proper alignment of the splitter puck 404 with the media player 403, allowing the first signal input 407 to receive a media signal while the second signal output 408 facilitates transmission of a processed signal and the first signal output 411 allows for transmission of the signal to an external device. Simultaneously, the power interface 410 connects to the power receiver 409, ensuring the media player 403 receives the required power independently from the signal transmission components.

In some embodiments, the splitter puck 404 enables signal duplication or routing, facilitating multiple output options while maintaining a compact form factor. In some embodiments, the splitter puck 404 includes a receiver for the power interface 410, which allows for seamless power and signal management along a single channel into the media player 403, as described supra. In some embodiments, the splitter puck 404 includes electrical components configured to manage signal routing, duplication, and transmission to external devices. For example, the splitter puck 404 may incorporate a signal processing circuit, which includes an integrated circuit (IC) configured to process incoming media signals.

Similar to other configurations, in some embodiments, the signal processing circuit includes an HDMI splitter or repeater IC configured to duplicate an HDMI signal for multiple output channels, ensuring simultaneous signal transmission to both the media player 403 and an external display. In some embodiments, the splitter puck 404 further includes a second signal output driver, which is configured to regulate the transmission of processed media signals to an external display or another device.

In some embodiments, the power interface 410 includes electrical components configured to regulate and distribute power to the media player 403. The power interface 410 may incorporate a power regulation circuit, similar to other configurations, which may include a voltage regulator configured to step down or stabilize the incoming voltage for system components. In some embodiments, a power management IC is included to monitor power distribution and ensure proper allocation to the media player 403. In some embodiments, the power interface 410 may also include overcurrent protection circuitry, which is configured to prevent excessive current draw that could damage connected components.

While accompanying description of figures in relation to some embodiments may describe fewer, more, or different components than other figures, it is understood that any electronic component or functionality described in relation to signal processing for the multifunction hub may be applied to the splitter puck, in accordance with some embodiments. Likewise, power delivering components described in relation to the multifunction hub may be integrated with the power interface, in accordance with some embodiments. Thus, descriptions of various configurations of the system are not limited to any particular figure.

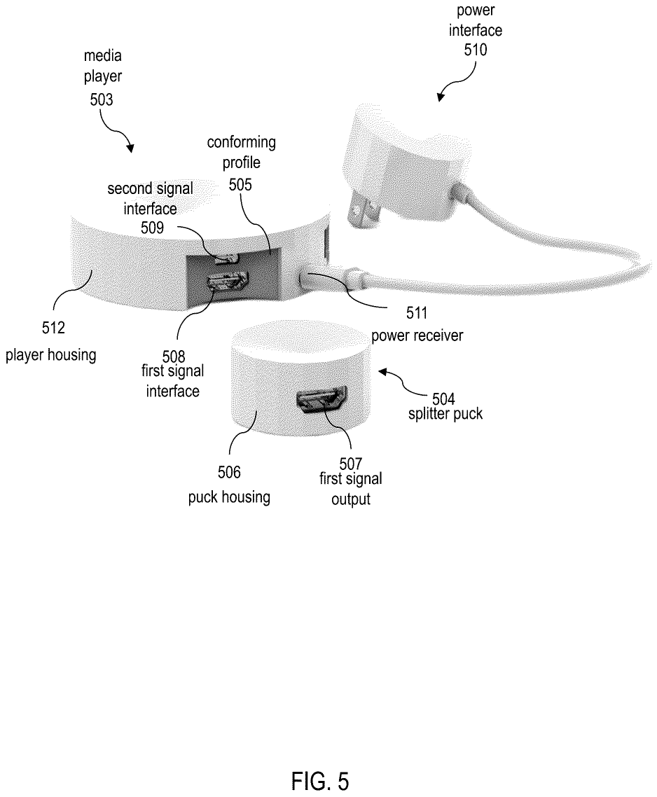

Referring now to FIG. 5, a full puck configuration of the system is shown in a decoupled state, illustrating the engagement between the media player 503, a splitter puck 504, and a power interface 510, in accordance with some embodiments. In contrast to FIG. 4, in some embodiments, the media player 503 player housing 512 includes a conforming profile 505, which is shaped to receive the splitter puck 504, rather than the puck housing having the conforming shape, as in the partial puck of FIG. 4. The modification alters the physical engagement between components but maintains the system's power and signal distribution functionality (e.g., signal duplication, routing), as described supra in relation to various figures. The different configurations allow for the puck to have a smaller profile when less electronic components are needed.

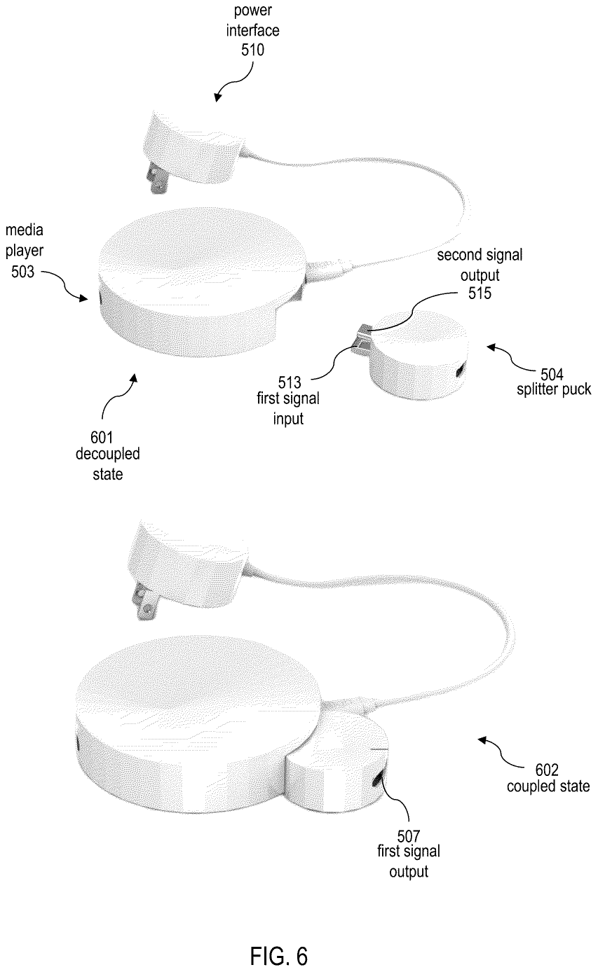

In some embodiments, the splitter puck 504 includes a puck housing 506 configured to align with the conforming profile 505 of the media player 503. The splitter puck 504 further includes a first signal output 507 and a second signal output 515 (illustrated in FIG. 6), which, in some embodiments, are configured to facilitate the transmission of media signals to the media player 503. In some embodiments, the media player 503 includes a second signal interface 509, which is configured to receive a processed signal for output or further distribution, similar to other examples described herein.

Similar to FIG. 4, in some embodiments, the power interface 510 is separately positioned from the splitter puck 504 and is configured to provide power directly to the media player 503 via the power receiver 511 on the player housing. In some embodiments, the power interface 510 (or power interface 410) is configured to couple to and interface on the housing of the splitter puck 504 (or splitter puck 404).

Referring now to FIG. 6, the system is shown in a decoupled state 601 and a coupled state 602, illustrating the engagement between the media player 503, the splitter puck 504, and the power interface 510, in accordance with some embodiments. In some embodiments, the media player 503 includes first signal interface 508, second signal interface 509, and power receiver 511 as distinct connection points, ensuring independent signal and power transmission.

In some embodiments, the decoupled state 601 illustrates the splitter puck 504 positioned apart from the media player 503, showing its independent connection points before engagement. In some embodiments, the splitter puck 504 includes a second signal output 515, which is configured to transmit a media signal back into the media player 503 or to an external device via second signal interface 509, in a similar manner as described in accordance with some embodiments above. The splitter puck 504 further includes a first signal input 513 for receiving the input signal from media player 503 via first signal interface 508. The power interface 510 is separately positioned from the splitter puck 504 and is configured to provide power directly to the media player 503 via the power receiver 511.

In some embodiments, the coupled state 602 illustrates the splitter puck 504 and the power interface 510 engaged with the media player 503. The first signal input 513 of the splitter puck 504 aligns with the first signal interface 508 and the second signal output 515 aligns with the second signal interface 509, facilitating media signal transmission, while the power interface 510 connects to the power receiver 511, in accordance with some embodiments.

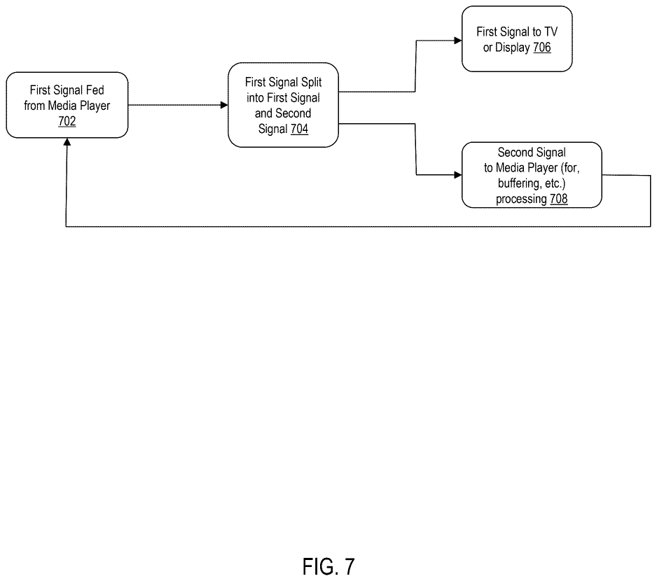

Referring now to FIG. 7, the signal processing flow is illustrated, showing the splitting and/or buffering of the HDMI signal for uninterrupted user experience, in accordance with some embodiments. In some embodiments, in step 702, the first signal is fed from the media player into the signal processing system of any configuration described herein, in accordance with some embodiments.

In some embodiments, in step 704, the first signal is processed through the signal splitter, which is configured to generate the first signal output and the second signal output. In step 706, the first signal output is configured to transmit the video signal to the external display, such as a computer, television, or monitor. In some embodiments, in step 708, he second signal output is configured to return the processed signal back to the media player for additional processing, buffering, or other operations necessary for uninterrupted playback.

In some embodiments, the system is configured to send the second signal to a buffer memory which ensures that the media player continues to receive a stable video stream even in cases of intermittent connectivity, frame drops, or temporary signal loss. The buffering process stores a portion of the incoming signal in the memory buffer, allowing for seamless playback by compensating for variations in signal timing.

In some embodiments, the returned signal is utilized to enable screen capture functionality, allowing the media player to extract individual frames for processing using the processing components of the media player. In some embodiments, the media player is configured to execute additional operations on the captured frames, including image analysis, content recognition, and metadata tagging. For example, the system may apply image enhancement techniques, such as sharpening, contrast adjustment, or noise reduction, to optimize visual clarity, in accordance with some embodiments. In some embodiments, the media player is further configured to analyze the returned signal for automated detection of specific visual elements, such as on-screen text, facial recognition, and/or overlay graphics.

Some embodiments of the system are presented with specific configurations, values, and/or setpoints. These values and setpoints are not intended to be limiting and are merely examples of a higher configuration versus a lower configuration and are intended as an aid for those of ordinary skill to make and use the system.

In some embodiments, the system can be described as including multifunction hub. In some embodiments, the multifunction hub includes one or more of a hub housing, a multifunction cable, a multifunction plug, a first signal input, a first signal output, and a second signal output. In some embodiments, the multifunction plug is coupled to a first end of the multifunction cable. In some embodiments, the multifunction plug includes the first signal input and the second signal output. In some embodiments, the hub housing is coupled to a second end of the multifunction cable. In some embodiments, the hub housing includes the first signal output. In some embodiments, the hub housing is configured to receive a digital signal from the first signal input. In some embodiments, the hub housing is configured to generate a first signal and a second signal from the digital signal. In some embodiments, the hub housing is configured to send the first signal to the first signal output. In some embodiments, the hub housing is configured to send the second signal to the second signal output.

In some embodiments, the hub housing includes one or more power inputs configured to receive electrical power. In some embodiments, the hub housing is configured to send both the electrical power and the second signal to the second signal output. In some embodiments, the electrical power is sufficient to power a digital media player. In some embodiments, the system further includes a digital media player. In some embodiments, the multifunction plug is configured to connect to one or more interfaces on a player housing of the digital media player.

Some embodiments of the system can be described as including a splitter puck. In some embodiments, the splitter puck includes one or more of a puck housing, a first signal input, a first signal output, and a second signal output. In some embodiments, the first signal input is located in a first quadrant of the puck housing. In some embodiments, the second signal output is located in the first quadrant of the puck housing. In some embodiments, the first signal output is located on a second quadrant of the puck housing.

In some embodiments, the puck housing does not include a cable extending therefrom. In some embodiments, the first signal input and the second signal output are configured to plug into a player housing of a media player simultaneously. In some embodiments, the first quadrant includes a puck shape configured to contour to a shape of the media player. In some embodiments, the puck housing is configured to receive a digital signal from the first signal input. In some embodiments, the puck housing is configured to generate a first signal and a second signal from the digital signal. In some embodiments, the puck housing is configured to send the first signal to the first signal output. In some embodiments, the puck housing is configured to send the second signal to second signal output. In some embodiments, the first signal and the second signal comprise same information as the digital signal.

In some embodiments, the system can be described as including a splitter puck and a media player. In some embodiments, the splitter puck includes a puck housing, a first signal input, a first signal output, and/or a second signal output. In some embodiments, the first signal input is located in a first quadrant of the puck housing. In some embodiments, the second signal output is located in the first quadrant of the puck housing. In some embodiments, the first signal output is located on a second quadrant of the puck housing. In some embodiments, the first signal input and the second signal output are configured to plug into a player housing of the media player simultaneously.

In some embodiments, the media player is configured to send a digital signal to the first signal input. In some embodiments, the puck housing is configured to receive the digital signal from the first signal input. In some embodiments, the puck housing is configured to generate a first signal and a second signal from the digital signal. In some embodiments, the puck housing is configured to send the first signal to the first signal output. In some embodiments, the puck housing is configured to send the second signal to the second signal output. In some embodiments, the first signal and the second signal comprise same information as the digital signal.

In some embodiments, wherein the puck housing does not include a cable extending therefrom. In some embodiments, the puck housing comprises a concave shape configured to conform to a convex shape on the player housing. In some embodiments, the player housing comprises a concave shape configured to conform to a convex shape on the puck housing.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured (e.g., degrees, volume, mass, distance).

As used herein, “can” or “may” or derivations thereof are used for descriptive purposes only and is understood to be synonymous and/or interchangeable with “configured to” when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

It will be appreciated by those skilled in the art that while the system has been described above in connection with some embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

We claim:

1. A system for media signal management, comprising:
a signal processing hub configured to:
receive a digital media signal from a media player;
process the digital media signal to generate a first output signal and a second output signal; and
transmit the first output signal to an external display device and the second output signal back to the media player;
wherein the signal processing hub further includes power delivery circuitry configured to provide electrical power to the media player through a single connection that provides the second output signal.

2. The system of claim 1, wherein the signal processing hub comprises:
a hub housing;
a multifunction cable extending from the hub housing; and
a multifunction plug coupled to an end of the multifunction cable, the multifunction plug configured to interface with the media player and including a first signal input and a second signal output.

3. The system of claim 2, wherein the hub housing includes power input prongs configured to couple to an AC power source.

4. The system of claim 1, wherein the signal processing hub includes signal conversion circuitry configured to convert the digital media signal between different signal formats.

5. The system of claim 4, wherein the signal conversion circuitry includes at least one of: HDMI-to-USB Type-C conversion circuitry, HDMI-to-DisplayPort conversion circuitry, or USB Type-C Alt Mode controller circuitry.

6. The system of claim 1, wherein the signal processing hub includes buffering circuitry configured to store a portion of the digital media signal to compensate for variations in signal timing.

7. A signal splitter device, comprising:
a housing;
a first signal interface located on the housing and configured to receive a digital media signal from a media player;
a signal processing circuit within the housing configured to duplicate the digital media signal into a first output signal and a second output signal;
a first signal output located on the housing and configured to transmit the first output signal to an external display; and
a second signal output located on the housing and configured to transmit the second output signal back to the media player for additional processing;
wherein the housing includes a conforming profile shaped to align with a corresponding profile of the media player.

8. The signal splitter device of claim 7, wherein the first signal interface and the second signal output are positioned on the housing to simultaneously connect with corresponding interfaces on the media player when the housing is aligned with the media player.

9. The signal splitter device of claim 7, wherein the housing comprises a concave shape configured to conform to a convex shape on the media player.

10. The signal splitter device of claim 7, further comprising a power input interface configured to receive electrical power and distribute the electrical power to the media player.

11. The signal splitter device of claim 7, wherein the signal processing circuit includes at least one of an HDMI splitter, an HDMI repeater, or a DisplayPort multiplier.

12. A media signal management system, comprising:
a media player having signal generation circuitry configured to produce a digital media signal; and
a splitter device physically separate from but coupleable to the media player, the splitter device configured to:
receive the digital media signal from the media player;
generate duplicate signals from the digital media signal; and
route a first duplicate signal to an external display device and a second duplicate signal back to the media player;
wherein the media player includes processing circuitry configured to perform signal analysis on the second duplicate signal received back from the splitter device.

13. The media signal management system of claim 12, wherein the processing circuitry is configured to extract individual frames from the second duplicate signal for screen capture functionality.

14. The media signal management system of claim 12, wherein the processing circuitry is configured to buffer the second duplicate signal to prevent signal interruption during playback.

15. The media signal management system of claim 12, wherein the processing circuitry is configured to analyze the second duplicate signal for automated detection of specific visual elements.

16. The media signal management system of claim 12, wherein the splitter device is configured to provide electrical power to the media player through a connection that also carries the second duplicate signal.

17. The media signal management system of claim 12, wherein the processing circuitry of the media player is further configured to:
buffer the second duplicate signal to prevent playback interruption;
perform image analysis on the second duplicate signal; and
extract one or more individual frames from the second duplicate signal for screen capture operations.

18. The media signal management system of claim 12, wherein the processing circuitry of the media player is further configured to automatically detect specific visual elements within the second duplicate signal while the first duplicate signal is simultaneously transmitted to the external display device.

19. The media signal management system of claim 12, wherein the splitter device comprises Extended Display Identification Data (EDID) storage circuitry configured to facilitate communication between the media player and the external display device.

20. The media signal management system of claim 12, wherein the splitter device comprises a USB Type-C data and power switching circuit configured to manage distribution of video signals and power through a USB Type-C output.
